(19) United States
(12) Patent Application Publication
(10) Pub. No.: US 2011/0003097 A1
(43) Pub. Date: Jan. 6, 2011

(54) HIGH QUALITY POROUS INK-JET MEDIA

(76) Inventors: Tienteh Chen, San Diego, CA (US); Xulong Fu, San Diego, CA (US); Rajasekar Vaidyanathan, San Diego, CA (US); Bryan Darr, San Diego, CA (US); Mark Drake, Temecula, CA (US); Christine E. Steichen, Escondido, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/865,078

(22) PCT Filed: Jan. 31, 2008
(86) PCT No.: PCT/US08/01411

§ 371 Date: Jul. 28, 2010

(51) Int. Cl. B41M 5/40; B41M 5/50; B05D 1/36

(52) U.S. Cl. 428/32.21; 427/411

(57) ABSTRACT

A print medium for ink-jet printing comprises a photobase substrate, a porous ink-receiving layer and a subbing layer. The photobase substrate can include paper and a moisture barrier layer coated on at least one side of the paper. The porous ink-receiving layer can include metal oxide or semi-metal oxide particulates treated with an organosilane reagent and aluminum chlorohydrate, and a polyvinyl alcohol binder. The subbing layer can be disposed between the moisture barrier layer of the photobase and the ink-receiving layer and include a polyvinyl alcohol or a copolymer of a polyvinyl alcohol.

### BACKGROUND OF THE INVENTION

There are several reasons that ink-jet printing has become a popular way of recording images on various media surfaces, particularly paper. Some of these reasons include low printer noise, capability of high-speed recording, and multi-color recording. Additionally, these advantages can be obtained at a relatively low price to consumers.

One area of ink-jet printing which has increased dramatically in popularity is photo printing. In order to achieve high quality and long lasting images, photos are typically printed on specialty media. Typically, the ink-receiving layers of such papers are adhered to a photobase substrate using a subbing layer of gelatin. Unfortunately, the use of gelatin as a binder in such papers frequently results in defects in the paper, particularly edge defects such as flaking and slivering during cutting and sheeting. Accordingly, research continues into developing printed photo media that has excellent image quality characteristics. Improvements in the subbing layer and ink-receiving layer(s) in combination would be an advancement in the art.

### DETAILED DESCRIPTION OF THE PREFERRED EMBODIMENT(S)

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

In describing and claiming the present invention, the following terminology will be used in accordance with the definitions set forth below.

It is noted that, as used in this specification and the appended claims, the singular forms “a,” “an,” and “the” include plural referents unless the context clearly dictates otherwise. Thus, for example, reference to “a polymer” includes one or more of such polymers, and reference to “the print medium” includes reference to one or more print mediums.

“Porous media coating” typically includes metal oxide or semi-metal oxide particulates, such as silica or alumina particulates, bound together by a polymeric binder. Optionally, mordants and/or other additives can also be present. Such additives can be water soluble coating formulation additives including multivalent salts, such as aluminum chlorohydrate; organosilane reagents chemically attached or unattached to the inorganic particulates; and/or acidic components such as acidic crosslinking agents, e.g., an acidic crosslinking agent that can be used to crosslink a polymeric binder, such as polyvinyl alcohol, is boric acid. The composition can be used as a coating for various media substrates, and can be applied by any of a number of methods known in the art. Additionally, such compositions can be applied in single layer or in multiple layers. If multiple layers are applied, then these multiple layers can be of the same or similar composition, or can be of different compositions.

“Aluminum complex” refers to any of a number of aluminum salts or other aluminum-containing materials, including aluminum chloride, aluminum chlorohydrate (ACH), aluminum hydroxy sulfate, aluminum hydroxy nitrate, etc.

“Aluminum chlorohydrate,” “ACH,” “polyaluminum chloride,” “PAC,” “polyaluminum hydroxychloride,” or the like, refer to a class of soluble aluminum products in which aluminum chloride has been partly reacted with a base. The relative amount of OH compared to the amount of Al can determine the basicity of a particular product. The chemistry of ACH is often expressed in the form Alₙ(OH)ₘCl(₃ₙ₋ₘ₎), wherein n can be from 1 to 50, and m can be from 1 to 150. Basicity can be defined by the term m/(3n) in that equation. ACH can be prepared by reacting hydrated alumina AlCl₃ with aluminum powder in a controlled condition. The exact composition depends upon the amount of aluminum powder used and the reaction conditions. Typically, the reaction can be carried out to give a product with a basicity of 40% to 83%. ACH can be supplied as a solution, but can also be supplied as a solid.

There are other ways of referring to ACH, which are known in the art. Typically, ACH comprises many different molecular sizes and configurations in a single mixture. An exemplary stable ionic species in ACH can have the formula [Al₁₂(OH)₂₄AlO₄(H₂O)₁₂]⁷⁺. Other examples include [Al₆(OH)₁₅]³⁺, [Al₈(OH)₂₀]⁴⁺, [Al₁₃(OH)₃₄]⁵⁺, [Al₂₁(OH)₆₀]³⁺, etc. Other common names used to describe ACH or components that can be present in an ACH composition include aluminum chloride hydroxide (8CI); A 296; ACH 325; ACH 331; ACH 7-321; Aloxicoll; Aloxicoll LR; aluminium hydroxychloride; Aluminol ACH; aluminum chlorhydrate; aluminum chlorohydroxide; aluminum chloride hydroxide oxide, basic; aluminum chloride oxide; aluminum chlorohydrate; aluminum chlorohydrol; aluminum chlorohydroxide; aluminum hydroxide chloride; aluminum hydroxychloride; aluminum oxychloride; Aquarhone; Aquarhone 18; Astringen; Astringen 10; Banoltan White; basic aluminum chloride; basic aluminum chloride, hydrate; Berukotan AC-P; Cartafix LA; Cawood 5025; Chlorhydrol; Chlorhydrol Micro-Dry; Chlorhydrol Micro-Dry SUF; E 200; E 200 (coagulant); Ekoflock 90; Ekoflock 91; GenPac 4370; Gilufloc 83; Hessidrex WT; HPB 5025; Hydral; Hydrofugal; Hyper Ion 1026; Hyperdrol; Kempac 10; Kempac 20; Kemwater PAX 14; Locron; Locron P; Locron S; Nalco 8676; OCAL; Oulupac 180; PAC; PAC (salt); PAC 100W; PAC 250A; PAC 250AD; PAC 300M; PAC 70; Paho 2S; PALC; PAX; PAX 11S; PAX 16; PAX 18; PAX 19; PAX 60p; PAX-XL 1; PAX-XL 19; PAX-XL 60S; PAX-XL 61S; PAX-XL 69; PAX-XL 9; Phacsize; Phosphonorm; (14) poly(aluminum hydroxy) chloride; polyaluminum chloride; Prodefloc AC 190; Prodefloc AL; Prodefloc SAB 18; Prodefloc SAB 18/5; Prodefloc SAB 19; Purachem WT; Reach 101; Reach 301; Reach 501; Sulzfloc JG; Sulzfloc JG 15; Sulzfloc JG 19; Sulzfloc JG 30; TAI-PAC; Taipac; Takibine; Takibine 3000; Tanwhite; TR 50; TR 50 (inorganic compound); UPAX 20; Vikram PAC-AC 100S; WAC; WAC 2; Westchlor 200; Wickenol 303; Wickenol CPS 325 aluminum chlorohydrate Al₂ClH₅O₅ or Al₂(OH)₅Cl.2H₂O or [Al(OH)₂Cl]ₓ or Al₆(OH)₁₅Cl₃; Al₂(OH)₅Cl]ₓ aluminum chlorohydroxide; aluminum hydroxychloride; aluminum chloride, basic; aluminum chloride hydroxide; [Al₂(OH)Cl₆₋ₙ]ₘ; [Al(OH)₃]ₙ AlCl₃; or Alₙ(OH)ₘCl₍₃ₙ₋ₘ₎ (where generally, 0<m<3n); for example. In one embodiment, such a composition can include aluminum chlorides and aluminum nitrates of the formula A1(OH)₂X to Al₃(OH)₈X, where X is Cl or NO₃. In another embodiment, compositions can be prepared by contacting silica particles with an aluminum chlorohydrate (Al₂(OH)₅Cl or Al₂(OH)Cl₅.nH₂O). It is believed that contacting a silica particle with an aluminum compound as described above causes the aluminum compound to become associated with or bind to the surface of the silica particles. This can be either by covalent association or through an electrostatic interaction to form a cationic charged silica, which can be measured by a Zeta potential instrument.

“Organosilane reagent” includes compositions that comprise a functional or active moiety which is covalently attached to a silane grouping. The organosilane reagent can become covalently attached or otherwise attracted to the surface of metal oxide or semi-metal oxide particulates, such as silica or alumina.

The term “ink-receiving layer(s)” refers to a layer or multiple coating layers that are applied to a media substrate, and which are configured to receive ink upon printing. As such, the ink-receiving layer(s) do not necessarily have to be the outermost layer, but can be a layer that is beneath another coating. Ink-receiving layer(s) are typically in the form of a porous media coating.

As used herein, the term “photobase” refers to a base paper, e.g., raw base paper, which is coated on at least one side with a moisture barrier layer. In one embodiment, the “photobase” is coated on both sides with a moisture barrier layer.

It is noted that ink jet inks as used in the present invention are generally known in the art and typically include liquid vehicles or ink vehicles. “Liquid vehicle” or “ink vehicle” refers to the liquid fluid in which colorant is placed to form an ink. Ink vehicles are well known in the art, and a wide variety of ink vehicles may be used with the systems and methods of the present invention. Such vehicles may include a mixture of a variety of different agents, including solvents, co-solvents, buffers, biocides, sequestering agents, viscosity modifiers, surface-active agents (surfactants), water, etc.

As used herein, “plurality” refers to more than one. For example, a plurality of polymers refers to at least two polymers.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not only the explicitly recited values of about 1 wt % to about 5 wt %, but also include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

Traditionally, ink-jet media for printing, such as polyethylene extruded photopaper or other photobase, is not in an acceptable condition for applying a porous media coating directly thereto. Thus, often, photobase is treated with a thin layer of gelatin in order to improve the adhesion between the ink-receiving layer and the photobase. Unfortunately, such print media frequently suffers from drawbacks in that the adhesion between the ink-receiving layer and the photobase substrate is poor, resulting in edge defects such as flaking and slivering during cutting and conversion. Previously, attempts to overcome the defects focused on the methods of sheeting, such as using reduced cutting speeds and/or using dual-rotary or guillotine cutters. This problem can be particularly problematic when the porous media coating includes additives in addition to the metal oxide or semi-metal oxide particulates and binder.

In contrast to this and other prior solutions, the present disclosure is drawn to a photographic quality ink-jet media sheet and method of making the same that can that has improved adhesion between the ink-receiving layer and the photo based paper and provides high image quality. In one embodiment, a print medium for ink-jet printing is provided which includes a photobase substrate, a porous ink-receiving layer, and a subbing layer. The photobase can include paper and a moisture barrier layer which is coated on at least one side of the paper. The porous ink-receiving layer can include metal oxide or semi-metal oxide particulates treated with organosilane reagent and aluminum chlorohydrate. Further, the porous ink-receiving layer can include a polyvinyl alcohol or copolymer of polyvinyl alcohol binder. A subbing layer can be disposed between the moisture barrier layer of the photobase substrate and the porous ink-receiving layer and can include polyvinyl alcohol or a copolymer of polyvinyl alcohol.

In another embodiment, a method of preparing a print medium for ink-jet printing can comprise the step of coating a subbing layer including polyvinyl alcohol or a copolymer of polyvinyl alcohol on a moisture barrier of a photobase substrate. Additional steps include treating metal oxide or semi-metal oxide particulates with an organosilane reagent and an aluminum complex to form treated particulates; and coating the treated particulates on the subbing layer using a binder of polyvinyl alcohol or copolymer of polyvinyl alcohol, thereby forming an ink-receiving layer.

### Subbing Layer

As mentioned, the subbing layer can include polyvinyl alcohol or polyvinyl alcohol copolymer, which can act to enhance the adhesion between the ink-receiving layer (which includes organosilane reagent and aluminum chlorohydrate) and the coating on the photobase substrate, thereby reducing flaking and slivering during processing, cutting, or the like. The polyvinyl alcohol or copolymer of polyvinyl alcohol used in the subbing layer can be made of any polyvinyl alcohol or copolymer of polyvinyl alcohol known in the arts. Non-limiting examples of polyvinyl alcohols and copolymers of polyvinyl alcohols that can be used include polyvinyl alcohol, polyethylene-co-polyvinyl alcohol, cationic polyvinyl alcohol, polyvinyl alcohol with acetoacetyl functional group, polyvinyl alcohol with a silanol functional group, anionic polyvinyl alcohol, polyvinylpyrrolidone-co-polyvinylalchol, polyvinyl alcohol-co-polyethyleneoxide, and combinations thereof. Appropriate weight average molecular weights of the polyvinyl alcohol or polyvinyl alcohol copolymer can range from 2000 Mw to 1,000,000 Mw, for example.

The polyvinyl alcohol or copolymer of polyvinyl alcohol used in the subbing layer can be 60% to 99.9% hydrolyzed. In one embodiment, the polyvinyl alcohol or copolymer of polyvinyl alcohol is 80 to 99% hydrolyzed. The polyvinyl alcohol or copolymer of polyvinyl alcohol can be, but does not have to be, crosslinked using a crosslinking agent. Non-limiting examples of crosslinking agents which may be used include boric acid, borate, glutaldehyde, formaldehyde, glyoxal, succinic dialdehyde, methylolmelamine, zinc salts, and/or aluminum salts. When used, the crosslinking agent can comprise about 0.1 wt % to about 15 wt % of the polyvinyl alcohol or copolymer of polyvinyl alcohol.

The polyvinyl alcohol or polyvinyl alcohol copolymer subbing layer can be applied to the photobase using any known method in the art including, but not limited to, Mylor rod application, roller application, a curtain coating process with corona treatment, or other known coating applications. The subbing layer can have a coat weight of from 0.01 g/m² and 2 g/m².

Photobase Substrate

The ink-jet recording medium can be formed on a photobase substrate. As defined above, photobase substrates can include raw base paper, generally referred to herein as “paper” or “paper substrate,” which is coated on at least one side with a moisture barrier layer.

In one embodiment, any number of traditionally used paper fiber substrates may be used to form the paper of the photobase substrate. Examples include, but are not limited to, any paper that includes fibers, fillers, additives, etc., used to form an image supporting medium. More specifically, the paper substrate in the form of a paper core may be made of any number of fiber types including, but not limited to, virgin hardwood fibers, virgin softwood fibers, recycled wood fibers, or the like.

In addition to the above-mentioned fibers, the paper substrate may include a number of filler and/or additive materials. In one embodiment, the filler materials include, but are not limited to, calcium carbonate (CaCO₃), clay, kaolin, gypsum (hydrated calcium sulfate), titanium oxide (TiO₂), talc, alumina trihydrate, magnesium oxide (MgO), minerals, and/or synthetic and natural fillers. In another embodiment, the paper substrate used in the photobase can comprise up to 30% by dry weight of fillers. Inclusion of the above-mentioned fillers can reduce the overall cost of the paper substrate in a number of ways. On the other hand, the inclusion of white filler such as calcium carbonate may enhance the brightness, whiteness, and the quality of the resulting image supporting medium.

Other additives or fillers that may be included include sizing agents such as metal salts of fatty acids and/or fatty acids, alkyl ketene dimer emulsification products and/or epoxidized higher fatty acid amides; alkenyl or alkylsuccinic acid anhydride emulsification products and rosin derivatives; dry strengthening agents such as anionic, cationic or amphoteric polyacrylamides, polyvinyl alcohol, cationized starch and vegetable galactomannan; wet strengthening agents such as polyaminepolyamide epichlorohydrin resin; fixers such as water-soluble aluminum salts, aluminum chloride, and aluminum sulfate; pH adjustors such as sodium hydroxide, sodium carbonate and sulfuric acid; optical brightening agents; and coloring agents such as pigments, coloring dyes, and/or fluorescent brighteners. Additionally, the paper substrate may include any number of retention aids, drainage aids, wet strength additives, de-foamers, biocides, dyes, and/or other wet-end additives.

In addition to the above-mentioned filler and additive materials, less than 20 wt % of the base substrate might be fine content, e.g., content having a particle size of 0.2-5 microns, and optionally, can include chopped or fragmented small woody fiber pieces formed during the refining process of the pulp. In one embodiment, the fine content may range from about 4 wt % to 10 wt % (dry).

The paper substrate used to form the photobase of the present disclosure can have a moisture barrier layer coated on either one or both sides of the paper. The moisture barrier layer on at least one side of the raw base substrate can be formed by an extrudable resin coating. In one embodiment, at least one side of paper or raw base substrate can be attached to an extruded moisture barrier layer, such as a moisture barrier layer made using polyethylene, polyvinylbutyral, and/or polypropylene. The barrier layer can include any polyolefin or other known material that is useful for such a layer. In one embodiment, the moisture barrier layer can be a low density polyethylene, a high density polyethylene, a polypropylene, or mixtures thereof.

In another embodiment, the moisture barrier layer can be coated onto a first and second side of the barrier layer. The first and second sides can be defined as being applied to opposing sides. In one embodiment, the moisture barrier layer can have a coat weight which is greater on either the first side or the second side of the paper compared to its opposing side. Alternatively, the coat weight can be the same on each opposing side. Further, in some embodiments, the coating material on each side can be of the same material in one embodiment. In other embodiments, the moisture barrier layer coated on the first side is compositionally distinct from the moisture barrier layer coated on the second side of the paper. Generally, the moisture barrier layer can have a coat weight on any one side of the paper substrate of about 10 g/m² to 50 g/m². The inclusion of a barrier layer on the paper substrate can provide a gloss or matte surface as well as a photo feel to the final ink-jet recording medium.

Ink-Receiving Layer

In accordance with embodiments of the present disclosure, one side of the photobase substrate can be coated with a single micro-porous ink-receiving layer, or alternatively, the micro-porous ink-receiving layer can comprise a plurality of layers. The micro-porous ink-receiving layer can include metal oxide or semi-metal oxide particulates, binder, organosilane reagent (optionally covalently attached to the particulates), and an aluminum complex, such as an aluminum chlorohydrate species or other aluminum salt.

In one embodiment, the metal oxide or semi-metal oxide particulate can be silica, alumina, titania, zirconia, aluminum silicate, and/or calcium carbonate. In one embodiment, the metal oxide or semi-metal oxide particulates can be cationically charged. As mentioned, the metal oxide or semi-metal oxide particulates can be treated with silane coupling agents containing functional groups that are interactive or reactive with other additives, such as aluminum chlorohydrate (ACH). If silica is used, it can be selected from the following group of commercially available fumed silica: Cab-O-Sil LM-150, Cab-O-Sil M-5, Cab-O-Sil MS-55, Cab-O-Sil MS-75D, Cab-O-Sil H-5, Cab-O-Sil HS-5, Cab-O-Sil EH-5, Aerosil 150, Aerosil 200, Aerosil 300, Aerosil 350, and Aerosil 400.

The metal oxide or semi-metal oxide particulates can include fumed silica (modified or unmodified), or the silica may be in colloidal form. Specifically, in one embodiment, the size of the fumed silica can be from approximately 50 to 300 nm in size. More specifically, the fumed can be from approximately 100 to 250 nm in size. The Brunauer-Emmett-Teller (BET) surface area of the fumed silica can be from about 100 to 400 m²/g. More specifically, the fumed silica can have a BET surface area of about 150 to 300 m²/g.

The substrate may be coated with an alumina (modified or unmodified). In one embodiment, the alumina coating can comprise pseudo-boehmite, which is aluminum oxide/hydroxide (Al₂O₃.n H₂O where n is from 1 to 1.5). Additionally, in another embodiment, the metal oxide or semi-metal oxide can include alumina that comprises rare earth-modified boehmite, such as those selected from lanthanum, ytterbium, cerium, neodymium, praseodymium, and mixtures thereof. Commercially available alumina particles can also be used, as are known in the art, including, but not limited to, Sasol Disperal HP10, boehmite, and Cabot SpectrAl 80 fumed alumina.

As mentioned above, the layer of metal oxide or semi-metal oxide, such as silica or alumina, can be treated with silane coupling agents containing functional groups and ACH, as well as other optional functional or modifying materials. When organosilanes are used, they can be covalently bound to the metal oxide or semi-metal oxide particulates. Organosilanes that may be used include methoxysilanes, halosilanes, ethoxysilanes, alkylhalosilanes, alkylalkoxysilanes, or other known reactive silane coupling agents, any of which may be further modified with one or more functional groups, including amine, epoxy, or heterocyclic aromatic groups. One organosilane reagent that can be used in accordance with the present disclosure is an amine containing silane, such as an amine silane, or more specifically in one embodiment, an aminosilane. To exemplify the organosilane reagents that can be used to modify such particulates, Formula I is provided, as follows:

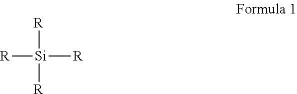

In Formula I above, from 0 to 2 of the R groups can be H, —CH₃, —CH₂CH₃, or —CH₂CH₂CH₃; from 1 to 3 of the R groups can be hydroxy, halide, or alkoxy; and from 1 to 3 of the R groups can be an organic active ligand, e.g., an amine. Examples of aminosilane reagents that can be used include 3-aminopropyltrimethoxysilane, 3-aminopropyltriethoxysilane, 3-aminoethylaminopropyltrimethoxysilane, 3-aminoethylaminopropyltriethoxysilane, 3-aminoethylaminoethylaminopropyltrimethoxysilane, 3-aminoethylaminoethylaminopropyltriethoxysilane, 3-aminopropylsilsesquioxane, (n-Butyl)-3-aminopropyltrimethoxysilane, (n-Butyl)-3-aminopropyltriethoxysilane, bis-(3-trimethoxysilylpropyl)amine, N-benzyl-N-aminoethyl-3-aminopropyltrimethoxysilane hydrochloride, N-phenyl-3-aminopropyltrimethoxysilane, N-(2-aminoethyl-3-aminopropyltrimethoxysilane, 3-(triethoxysilylpropyl)-diethylenetriamine, poly(ethyleneimine) trimethoxysilane, combinations thereof, or the like. When used, the amine-containing organosilance can be added at a weight ration of amine-containing organosilane to metal oxide of 1:50 to 1:5.

In one embodiment, the porous media coating composition can also include an aluminum chlorohydrate. For example, the organosilane reagent can be reacted with aluminum chlorohydrate. The organosilane and the aluminum chlorohydrate can function together to treat the metal oxide or semi-metal oxide, e.g. fumed silica, from being negatively charged to being cationically charged. It has been recognized that good printing results, as well as good adhesion through a polyvinyl alcohol (or copolymer) subbing layer, can be obtained when ACH is reacted with aminosilane coupling agent first in an aqueous medium to form a complex of sorts. The exact structure is difficult to predict or know, but the overall interaction can provide beneficial printing results. In one preparatory example, such a “complex” is believed to form by a covalent bonding with the fumed silica surface, and the powder of fumed silica can then be dispersed into an aqueous solution comprising the adduct of ACH and an aminosilane. When included, the aluminum chlorohydrate can be reacted with the organosilane reagent at a weight ration of aluminum chlorohydrate to organosilane of 1:10 to 5:1. The ink-receiving layer can further include a polyvinyl alcohol binder. Additionally, the porous ink-receiving layer may also include any number of surfactants, buffers, plasticizers, and other additives that are known in the art.

During application, the micro-porous ink-receiving layer can be coated onto the substrate by any number of material dispensing machines including, but not limited to, a slot coater, a curtain coater, a cascade coater, a blade coater, a rod coater, a gravure coater, a Mylar rod coater, a wired coater, or the like. Generally, the porous ink-receiving layer can have a coat weight of 10 g/m² to 40 g/m².

### EXAMPLES

The following examples illustrate various aspects of the ink print medium in accordance with embodiments of the present invention. The following examples should not be considered as limitations of the invention, but merely teach how to make the best print media presently known.

### Example 1

### Preparation of Cationic Fumed Silica for Ink-Receiving Layer Using Cabot MS-55 Treated with ACH and Dynasylan 1189

Cationic fumed silica was produced as follows: a 3 liter stainless steel vessel was charged with 1265 g of deionized water, 28.8 g of ACH (50% solution from Clariant), and 43.2 g of n-butyl-3-aminopropyltrimethoxysilane (Dynasylan 1189 from Degussa). The mixture was sheared with a Kady lab rotor/stator for 15 minutes. 480 g of Cabot MS-55 was then added slowly to the mixture and the shearing increased to 60 Hz. The total addition time was about one hour. The dispersion was filtered through a 10 μm bag filter and cooled to room temperature. Z-average particle size measured by Malvern PCS was 109 nm.

### Example 2

### Preparation of Cationic Fumed Silica for Ink-Receiving Layer Using Cabot MS-55 Treated with ACH and Silquest A-1110

In a 3 liter stainless steel vessel was charged with 1265 g of deionized water, 28.8 g of ACH (50% solution from Clariant), and 32.9 g of 3-aminopropyltrimethoxysilane (Silquest A-1110 from Gelest). The mixture was sheared with a Kady lab rotor/stator at 30 Hz for 15 minutes. About 480 g of Cabot MS-55 was then added slowly to the mixture and the shearing increased to 60 Hz. The total addition time was about one hour. The dispersion was filtered through a 10 μm bag filter and cooled to room temperature. Z-average particle size measured by Malvern PCS was 112 nm.

### Example 3

### Preparation of Cationic Fumed Silica for Ink-Receiving Layer Using Orisil 200 Treated with ACH and Silquest A-1110

Cationic fumed silica was produced as follows. A 3 liter stanless steel vessel was charged with 1265 g of deionized water, 23.0 g of ACH (50% solution from Clariant), and 26.32 g of 3-aminopropyltrimethoxysilane (Silquest A-1110 from Gelest). The mixture was sheared with as in Example 1 for 15 minutes. About 480 g of Orisil 200 fumed silica was then added slowly to the mixture and the shearing increased to 60 Hz. The total addition time was about one hour. The dispersion was filtered through a 10 nm bag filter and cooled to room temperature. Z-average particle size measured by Malvern PCS was 138 nm.

### Example 4

### Preparation of Cationic Fumed Silica for Ink-Receiving Layer Using Orisil 200 Treated with ACH and Silquest A-1100

In a 3 liter stainless steel vessel was charged with 1265 g of deionized water, 23.0 g of ACH (50% solution from Clariant), and 32.5 g of 3-aminopropyltrimethoxysilane (Silquest A-1100 from Gelest). The mixture was sheared with a Kady lab rotor/stator at 30 Hz for 15 minutes. About 480 g of Orisil 200 fumed silica was then added slowly to the mixture and the shearing increased to 60 Hz. The total addition time was about one hour. The dispersion was filtered through a 10 nm bag filter and cooled to room temperature. Z-average particle size measured by Malvern PCS was 141 nm.

### Example 5

### Preparation of Cationic Fumed Silica for Ink-Receiving Layer Using Orisil 150 Treated with ACH and Silquest A-1110

In a 3 liter stanless steel vessel was charged with 1265 g of deionized water, 17.28 g of ACH (50% solution from Clariant), and 19.74 g of 3-aminopropyltrimethoxysilane (Silquest A-1110 from Gelest). The mixture was sheared with a Kady lab rotor/stator at 30 Hz for 15 minutes. About 480 g of Orisil 150 fumed silica was then added slowly to the mixture and the shearing increased to 60 Hz. The total addition time was about one hour. The dispersion was filtered through a 10 nm bag filter and cooled to room temperature. Z-average particle size measured by Malvern PCS was 155 nm.

### Example 6

### Preparation of Porous Ink-Jet Media

A porous ink-jet media was prepared as follows:

a) Preparation of Photo Base Paper with Polyvinyl Alcohol Subbing Layer

A 166 or 171 g/m² raw base paper was used for this example. The raw base paper was passed through two extruders to apply polyethylene (PE) moisture barrier layer on the front side and back side of the paper in sequence. The aqueous solutions of polyvinyl alcohols (“PVA 1-8” in Table 1a) and gelatin (“Gelatin” in Table 1 as comparison example) were applied to the front side of the photo paper with a roller coater. The formulations of various subbing solutions including the control are shown in Tables 1a and 1b, where 1a indicates the base polymer and 1b indicates the base polymer with (or without) a hardener.

TABLE 1a

| | | PVA | |
|---|---|---|---|
| | Percent | Viscosity | |
| Polymer | Hydrolysis | (4% @ 20° C) | Functional |
| ID | of PVA | CPS | Group |
| Gelatin | — | — | — |
| PVA 1 | 88 | 26 | — |
| PVA 2 | 88 | 40 | — |
| PVA 3 | 98 | 56 | — |
| PVA 4 | 88 | 56 | — |
| PVA 5 | 88 | 100 | — |
| PVA 6 | 96 | 13 | Acetoacetyl |
| | | | group |
| PVA 7 | 86-88 | 18-22 | Cationic |
| | | | Group |
| PVA 8 | 88 | 8 | PEO grafted |

TABLE 1b

| Subbing Layer | | | |
|---|---|---|---|
| Composition | | | Wt. % of |
| ID | Polymer | Hardener | Hardener |
| 1 | Gelatin | Al salt | 2.7% |
| 2 | PVA 1 | None | — |
| 3 | PVA 2 | None | — |
| 4 | PVA 3 | Al salt | 2.7% |
| 5 | PVA 4 | Boric | 5% |
| 6 | PVA 5 | Boric Acid | 5% |
| 7 | PVA 5 | Glyoxal | 10% |
| 8 | PVA 6 | None | — |
| 9 | PVA 7 | Boric acid | 2% |
| 10 | PVA 8 | None | — |

b) Ink-Receiving Bottom Layer

The coating formulations of the ink-receiving layer comprising silica as described above in Examples 1 to 5 are described in Table 2.

TABLE 2

| | Formula 1 | Formula 2 | Formula 3 | Formula 4 | Formula 5 |
|---|---|---|---|---|---|
| | (Parts by | (Parts by | (Parts by | (Parts by | (Parts by |
| | weight) | weight) | weight) | weight) | weight) |
| Example 1 | 100 | | | | |
| Treated Silica | | | | | |
| Example 2 | | 100 | | | |
| Treated Silica | | | | | |
| Example 3 | | | 100 | | |
| Treated Silica | | | | | |
| Example 4 | | | | 100 | |
| Treated Silica | | | | | |
| Example 5 | | | | | 100 |
| Treated Silica | | | | | |
| PVA 5 | 21 | 21 | 21 | | |
| PVA 2 | | | | 21 | 19 |
| Boric Acid | 2.5 | 2.5 | 2.5 | 2.5 | 2 |
| Zonyl FSN | 0.1 | 0.1 | 0.1 | 0.1 | 0.1 |
| | Wt % Solid | Wt % Solid | Wt % Solid | Wt % Solid | Wt % Solid |
| | 19.5 | 19.5 | 19.5 | 21 | 22 |
| | Coat | | Coat | | |
| | weight | Coat weight | weight | Coat weight | Coat weight |
| | (gsm) | (gsm) | (gsm) | (gsm) | (gsm) |
| | 28 | 28 | 28 | 25 | 20 |

c) Glossy Top Layer

A glossy top layer is coated on the top of the ink-receiving bottom layer to improve gloss and handlebility. It is noted that the combination of these two layers make up the “ink-receiving layer” in this embodiment. The glossy top layer used included Boehmite HP-14, Cartacoat K303C, and polyvinyl alcohol. The coat weight was 0.5 g/m².

d) The Manufacture of Two Layered Porous Inkjet Media

Two layered porous ink-jet media sheets including a glossy top layer and ink-receiving layer are produced with a single pass (wet-on-wet) coating method using a curtain coater. The first applied layer is the ink-receiving layer and the second applied layer is the glossy layer. The ink-receiving layer and the glossy layer are applied to photobase having a subbing layer. The photobase and subbing layers which are used are set forth in Table 3 below. The coat weight of the ink-receiving layer is from 10 to 40 gsm and the coat weight of the glossy layer is from 0.1 to 2 gsm.

e) Sheeting Test and Results

The porous ink-jet media set forth in Table 3 (below) is converted to a 4×6 sheets with a Womako Photocut 92 sheeter. Flakes and silvering are seen in unsupported slit edge or cross cut edges with regular gel subbed photo base. Slivers is narrow strands of coating falling off edges of paper. “Flakes” refers to larger chips of coating falling off from edges of photo paper. When the running speed of the sheeter is increased, the flaking typically increases. Flaking is visually evaluated. 100 4×6 photo papers are printed borderless, and handled after printing, then visually checked for any flaking defects. When 5 or more sheets per 100 prints have large flaking, the performance of the media is rated as “bad”. If flaking occurs in zero or 1 per 100 sheets the performance of the media is rated as “good.” When flaking occurs in 2-5 per 100 sheets the performance of the media is rated as “marginal.” As shown in Table 3, the porous ink-jet media coated on the PVA subbed photo base have much lower defects than that of the traditional gelatin subbed photo base paper.

TABLE 3

| | | | Subbing | Photobase | | | |
|---|---|---|---|---|---|---|---|
| Ink- | Subbing | | Coat | Raw | Front | Back | |
| receiving | Layer | Subbing | Weight | Paper | PE | PE | Re- |
| Layer | Composition | Polymer | (mgsm) | (gsm) | (gsm) | (gsm) | sult |
| Formula 1 | 1 | gelatin | 250 | 171 | 18 | 18 | Bad |
| Formula 1 | 1 | gelatin | 80 | 171 | 24 | 42 | Bad |
| Formula 1 | 1 | gelatin | 80 | 166 | 20 | 38 | Bad |
| Formula 1 | 4 | PVA 3 | 80 | 166 | 20 | 38 | Good |
| Formula 1 | 4 | PVA 3 | 120 | 166 | 19 | 15 | Good |
| Formula 2 | 4 | PVA 3 | 80 | 166 | 20 | 38 | Good |
| Formula 2 | 4 | PVA 3 | 120 | 166 | 19 | 15 | Good |
| Formula 1 | 5 | PVA 5 | 80 | 166 | 20 | 38 | Good |

Of course, it is to be understood that the above-described formulations and arrangements are only illustrative of the application of the principles of the present invention. Numerous modifications and alternative arrangements may be devised by those skilled in the art without departing from the spirit and scope of the present invention and the appended claims are intended to cover such modifications and arrangements.

What is claimed is:

1. A print medium for ink-jet printing, comprising:
a) a photobase substrate, including:
i) paper, and
ii) a moisture barrier layer coated on at least one side of the paper;
b) a porous ink-receiving layer, including:
i) metal oxide or semi-metal oxide particulates treated with an organosilane reagent and an aluminum complex, and
ii) a polyvinyl alcohol or copolymer of polyvinyl alcohol binder; and
c) a subbing layer including polyvinyl alcohol or a copolymer of polyvinyl alcohol, said subbing layer disposed between the moisture barrier layer of the photobase and the porous ink-receiving layer.

2. A print medium as in claim 1, wherein the metal oxide or semi-metal oxide particulates is cationically charged.

3. A print medium as in claim 1, wherein the aluminum complex is an aluminum chlorohydrate.

4. A print medium as in claim 3, wherein the aluminum chlorohydrate is reacted with the organosilane reagent at a weight ratio of aluminum chlorohydrate to organosilane of 1:10 to 5:1.

5. A print medium as in claim 1, wherein the moisture barrier layer is a low density polyethylene, high density polyethylene, polypropylene, or mixtures thereof.

6. A print medium as in claim 1, wherein the moisture barrier layer on at the least one side has a coat weight from 10 g/m² to 50 g/m².

7. A print medium as in claim 1, wherein the metal oxide or semi-metal oxide particulates are selected from the group consisting of silica, alumina, titania, zirconia, aluminum silicate, calcium carbonate, and combinations thereof.

8. A print medium as in claim 1, wherein the metal oxide or semi-metal oxide particulates include silica particulates, said silica particulates comprising fumed silica having a surface area of 100 to 400 m²/g.

9. A print medium as in claim 1, wherein the organosilane reagent is an amine-containing organosilane.

10. A print medium as in claim 9, wherein the amine-containing organosilane is added at a weight ratio of amine-containing organosilane to metal oxide of 1:50 to 1:5.

11. A print medium as in claim 9, wherein the amine-containing silane is selected from the group consisting of 3-aminopropyltrimethoxysilane, 3-aminopropyltriethoxysilane, 3-aminoethylaminopropyltrimethoxysilane, 3-aminoethylaminopropyltriethoxysilane, 3-aminoethylaminoethylaminopropyltrimethoxysilane, 3-aminoethylaminoethylaminopropyltriethoxysilane, 3-aminopropylsilsesquioxane, (n-Butyl)-3-aminopropyltrimethoxysilane, (n-Butyl)-3-aminopropyltriethoxysilane, bis-(3-trimethoxysilylpropyl)amine, N-benzyl-N-aminoethyl-3-aminopropyltrimethoxysilane hydrochloride, N-phenyl-3-aminopropyltrimethoxysilane, N-(2-aminoethyl-3-aminopropyltrimethoxysilane, 3-(triethoxysilylpropyl)-diethylenetriamine, poly(ethyleneimine) trimethoxysilane, and combinations thereof.

12. A print medium as in claim 1, wherein the ink-receiving layer has a total coat weight of 10 g/m² to 40 g/m².

13. A print medium as in claim 1, wherein the polyvinyl alcohol or copolymer of polyvinyl alcohol in the subbing layer is 60% to 99.9% hydrolyzed.

14. A print medium as in claim 1, wherein the polyvinyl alcohol or copolymer of polyvinyl alcohol in the subbing layer is 80% to 99% hydrolyzed.

15. A print medium as in claim 1, wherein the coat weight of the subbing layer is from 0.01 to 2 g/m².

16. A print medium as in claim 1, wherein the polyvinyl alcohol or copolymer of polyvinyl alcohol is selected from the group consisting of polyvinyl alcohol, polyethylene-co-polyvinyl alcohol, cationic polyvinyl alcohol, polyvinyl alcohol with acetoacetyl functional group, polyvinyl alcohol with a silanol functional group, anionic polyvinyl alcohol, polyvinylpyrrolidone-co-polyvinylalchol, polyvinyl alcohol-co-polyethyleneoxide, and combinations thereof.

17. A print medium as in claim 1, wherein the polyvinyl alcohol or copolymer of polyvinyl alcohol is crosslinked with a crosslinking agent.

18. A print medium as in claim 18, wherein the crosslinking agent is selected from boric acid, borate, glutaldehyde, formaldehyde, glyoxal, succinic dialdehyde, methylolmelamine, zinc salts, aluminum salts.

19. A print medium as in claim 18, wherein the crosslinking agent comprises 0.1 wt % to 15 wt % of the polyvinyl alcohol or copolymer of polyvinyl alcohol in the subbing layer.

20. A print medium as in claim 1, wherein the subbing layer has a coat weight of from 0.01 g/m² and 2 g/m².

21. A method of preparing a print medium for ink jetprinting, comprising:
a) coating a subbing layer including polyvinyl alcohol or a copolymer of polyvinyl alcohol on a moisture barrier of a photobase substrate;
b) treating metal oxide or semi-metal oxide particulates with an organosilane reagent and an aluminum complex to form treated particulates; and
c) coating the treated particulates on the subbing layer using a binder of polyvinyl alcohol or copolymer of polyvinyl alcohol, thereby forming an ink-receiving layer.

22. A method as in claim 21, wherein the metal oxide or semi-metal oxide particulates are cationically charged.

23. A method as in claim 21, wherein the aluminum complex is an aluminum chlorohydrate.

24. A method as in claim 21, wherein the step of coating the subbing layer on the moisture barrier is at a coat weight from 0.01 g/m² and 2 g/m².

25. A method as in claim 21, wherein the polyvinyl alcohol or copolymer of polyvinyl alcohol is crosslinked with a crosslinking agent.
